(19) United States
(12) Patent Application Publication
(10) Pub. No.: US 2014/0342046 A1
(43) Pub. Date: Nov. 20, 2014

(54) NATURAL BEVERAGE CONCENTRATE

(71) Applicants: Joseph A. Ackilli, South Salem, NY (US); Harry Topalian, Weston, CT (US)

(72) Inventors: Joseph A. Ackilli, South Salem, NY (US); Harry Topalian, Weston, CT (US)

(21) Appl. No.: 14/265,530

(22) Filed: Apr. 30, 2014

Related U.S. Application Data
(60) Provisional application No. 61/855,398, filed on May 15, 2013.

(51) Int. Cl. A23L 2/385; A23L 2/60; A23L 2/68; A23L 2/56

(52) U.S. Cl. CPC A23L 2/385; A23L 2/56; A23L 2/60; A23L 2/68
USPC 426/72; 426/590

(57) ABSTRACT

Flavoring concentrate compositions and a corresponding process for producing such compositions are provided that include: a flavor component; a solvent system; a sweetener; an acid; and water, wherein the water is present in the composition in an amount to achieve a water activity of about 0.6 to about 0.75.

The present application claims priority to U.S. Provisional Patent Application No. 61/855, 398, filed May 15, 2013, which is incorporated herein by reference in its entirety.

### BACKGROUND

The present application generally relates to natural beverage flavoring concentrates. More particularly, the present application relates to flavoring concentrates having intermediate moisture that eliminates or otherwise ameliorates the need for artificial preservatives.

The market for flavored beverages has increased at a dramatic rate, and today is a multibillion dollar industry. In many instances, flavored beverages are prepared at the point of consumption, for example, using soft drink dispenser, by mixing the flavoring concentrate with water (carbonated or otherwise). These concentrates, however, typically contain artificial flavors, colors, sweeteners and preservatives, which results in limited acceptance of the soft drink. Accordingly, there is a need for a flavoring concentrate that is not so limited.

### SUMMARY

In at least one aspect of the invention, a flavoring concentrate composition is provided that includes: a flavor component; a solvent system; a sweetener; an acid; and water, wherein the water is present in the composition in an amount to achieve a water activity of about 0.6 to about 0.75.

In at least one embodiment, the solvent system comprises propylene glycol in an amount from about 35 wt. % to 45 wt. % of the composition.

In at least one embodiment, the flavor component comprises at least one flavor selected from a group consisting of berry, orange, lemon, strawberry, kiwi, grape, peach, coconut, and punch.

In at least one embodiment, the flavor component is present in the composition in an amount from about 2 wt. % to about 8 wt. %.

In at least one embodiment, the acid comprises at least one acid selected from a group consisting of citric acid, malic acid, tartaric acid, fumaric acid, and phosphoric acid.

In at least one embodiment, the acid comprises citric acid and wherein the citric acid is present in the composition in an amount from about 8 wt. % to about 20 wt. %.

In at least one embodiment, the acid comprises potassium citrate and wherein the potassium citrate is present in the composition in an amount from about 0.5 wt. % to about 2 wt. %.

In at least one embodiment, the acid comprises citric acid in an amount from about 8 wt. % to about 20 wt. % of the composition and potassium citrate in an amount from about 0.5 wt. % to about 2 wt. % of the composition.

In at least one embodiment, the composition further comprising an additive selected from a group consisting of vitamins, herbal supplements, colorings, minerals, bioactives, fiber, hydrocolloids, such xanthan.

In at least one embodiment, the composition further comprising at least one of inulin and maltodextrine.

In at least one embodiment, the composition is a liquid.

In at least one embodiment, the composition is a gel.

In at least one embodiment, the sweetener is stevia leaf extract.

In at least one embodiment, the stevia is present in the composition in an amount from about 2 wt. % to about 4 wt. %.

In another aspect, a process for preparing a flavoring concentrate composition is provided that includes the steps of: heating water to about 180 degrees F.; adding an acid, sweetener, and a solvent system to the water to form an initial blend; mixing the initial blend; cooling the initial blend to about 90 degrees F.; adding a flavor component to the blend to form a flavored blend; mixing the flavored blend to form the flavoring concentrate composition; and packaging the flavoring concentrate composition, wherein the water is present in the composition in an amount to achieve a water activity of about 0.6 to about 0.75.

In another aspect, a flavoring concentrate composition is provided that includes: a flavor component; a solvent system; a sweetener; an acid; and water, wherein: the water is present in the composition in an amount to achieve a water activity of about 0.6 to about 0.75; the solvent system comprises propylene glycol in an amount from about 35 wt. % to 45 wt. % of the composition; the flavor component is present in the composition in an amount from about 2 wt. % to about 8 wt. %; and the acid comprises citric acid in an amount from about 8 wt. % to about 20 wt. % of the composition and potassium citrate in an amount from about 0.5 wt. % to about 2 wt. % of the composition.

Additional aspects of the present invention will be apparent in view of the description which follows.

### DETAILED DESCRIPTION

The present application is directed to novel compositions for flavoring concentrate generally having a flavor component, a solvent system, a flavor carrier system, an acidifier and natural intensive sweeteners in any adaptive combination of the same. Preferably, the flavoring concentrate has a water content minimized to achieve intermediate moisture with water activity between about 0.60 and about 0.75. This water activity level prevents or otherwise reduces microbial growth without the use of preservatives. That is, the concentrate may be formulated so as not include or otherwise contain any preservatives. Moreover, the concentrate compositions may also have all ingredients thereon completely dissolved, and be physically and microbiologically stable. This may be achieved by having the correct ratio of solvents and water to insure good solubility while maintaining low water activity.

The flavoring concentrate compositions of the present application are preferably dispensable as a gel or liquid concentrate.

In at least one embodiment, the flavoring concentrate compositions discussed herein have a flavor component for imparting a palatable flavor to water. The flavor may be the component of the composition containing all flavors, i.e., the component that imparts a particular taste, with the exception of sweetener. Preferably, the flavor component of the flavoring concentrates discussed herein is a natural substance selected from among various types of flavors, including fruit flavors, botanical flavors, etc. and mixtures thereof. The flavor component can comprise a single flavor or blended flavors.

Flavor components useful in the flavoring concentrate compositions are sometimes available as dry ingredients, liquids of emulsions, etc. In any of these forms, the flavor components can be dispersed into the flavoring concentrate compositions to provide the desired taste in the final product. In addition to the active flavor itself, industrially available flavor components can contain, weighting agents, emulsifier, emulsion stabilizers, antioxidants, and the like. Examples of suitable flavors for use in the flavoring concentrate compositions discussed herein include, for example, berry, orange, lemon, strawberry, kiwi, grape, peach, coconut, punch or any combination thereof.

The flavor component is preferably present in the flavoring concentrate composition in an amount from about 1 percentage by weight (wt. %) to about 10 wt. % of the total weight of the concentrate composition. More preferably, the flavor component is present in an amount from about 1 wt. % to 8 wt. % of the composition.

The flavoring concentrate composition may also have a flavor carrier system. The flavor carrier system functions as a carrier for the flavor additives, thereby assisting in the dispersion of the resultant flavor concentrate. Suitable flavor carriers for use in the flavoring composition include, for example, propylene glycol, ethyl alcohol, triacetin, glycerol and any combinations thereof. The flavor carrier may comprise propylene glycol and ethyl alcohol. Preferably, propylene glycol is present in the composition in an amount from about 5 wt. % to about 35 wt. % of the composition. Ethyl alcohol may be present in the composition in an amount from about 10 wt. % to about 60 wt. % of the composition.

The flavoring concentrate composition may further include a solvent system in an amount from about 30 wt. % to about 50 wt. % of the total weight of the flavoring concentrate composition. In a preferred embodiment, the solvent is present in an amount about 35 wt. % to about 45 wt. %. Suitable solvents include 1, 2 propanediol, 1, 3 propanediol and glycerol.

The flavoring concentrate compositions may further include an acidifier. Suitable acids for use in the flavoring compositions include, for example, citric acid, malic acid, tartaric acid, fumaric acid, phosphoric acid, or an suitable recognized in the flavoring industry, and any combinations thereof.

In a preferred embodiment, the acidifier is an acid used in combination with potassium or sodium citrate. In a more preferred embodiment, the acid is citric acid and potassium citrate. Citric acid is preferably present in the flavoring composition in a amount from about 5 wt. % to about 20 wt. % of the total weight of the composition. Potassium citrate is preferably present in the flavoring composition in an amount from about 0.25 wt. % to about 1 wt. % of the total weight of the composition.

Suitable non-caloric sweeteners for use in the flavoring concentrate compositions include, for example, stevia leaf extract or other high intensive natural sweeteners. The sweetener may be present in the flavoring concentrate composition in an amount from about 1 wt. % to about 5 wt. % of the total weight of the composition. Preferably, the sweetener is present in an amount from about 2 wt. % to about 4 wt. %.

The flavoring concentrate compositions may optionally include one or more additional functional components such as flavor enhancers, food-approved colors, vitamins, minerals, flow agents, etc. Typical colorants are any of those suitable for achieving the desired color. Additional suitable components for the flavoring composition concentrates include, for example bioactives, herbal supplements, magnesium, calcium, potassium and sodium citrate salts, hydrocolloids, such xanthan, or any combinations thereof.

The compositions are described in the following Examples in Table A, which are set forth to aid in the understanding of the invention, and should not be construed to limit in any way the scope of the invention as defined in the claims which follow thereafter.

### EXAMPLES

TABLE A
Flavoring Concentrate Compositions (wt %)

| | COCONUT | PUNCH | LEMON | BERRY | ORANGE | GRAPE |
|---|---|---|---|---|---|---|
| PROPYLENE GLYCOL % | 40 | 40 | 40 | 40 | 40 | 40 |
| COLOR | 1 | 1 | 1 | 1 | 1 | 1 |
| POTASSIUM CITRATE | 0.5 | 0.5 | 0.5 | 0.5 | 0.5 | 0.5 |
| CITRIC ACID | 15 | 14 | 19 | 15 | 16 | 16 |
| FLAVOR | 4 | 4 | 6 | 6 | 4 | 4 |
| STEVIA EXTRACT | 2.5 | 3 | 2.5 | 3 | 2.5 | 3 |
| WATER | 36 | 34 | 30 | 32 | 36 | 35.5 |
| INULIN (FILLER) | 1 | 3.5 | 1 | 2.5 | 0 | 0 |
| TOTAL | 100 | 100 | 100 | 100 | 100 | 100 |
| WATER ACTIVITY | 0.74 | 0.65 | 0.62 | 0.64 | 0.74 | 0.74 |

The above compositions of Table A are formulated by heating deionized water to 180 degrees F. plus or minus 5 degrees F. All ingredients are added to the heated water except for the flavor component. The mixture is mixed with adequate stirring for about 15 minutes. Temperature is then dropped or otherwise allowed to drop to 100 degrees F. The flavor component, preferably in liquid form, is then added to the mixture and mixed/stirred for 5 minutes. The resulting flavoring concentrate is then allowed to cool further for packaging. The concentrate is preferably packaged with the concentrate at 70 degrees F. to 90 degrees F.

A standard batch of flavoring concentrate generates approximately 1000 pound of concentrate in liquid form. In a preferred embodiment about 30 wt. % to about 36 wt. %, or more preferably 35 wt. % of the flavoring concentrate is water; about 12 wt. % to about 17 wt. % of the flavoring concentrate is acid; about 2.5 wt. % to 3 wt. % of the flavoring concentrate is sweetener; and about 35 wt. % to about 45 wt. %, or more preferably 40 wt. % of the flavoring concentrate is a solvent system. It is believed that compositions having these ranges result in the desired water activity of between about 0.60 and about 0.75.

The flavoring concentrates may be packaged/pre-measured for single serving use, for example, for use with a standard 12 or 16 ounce water bottles. The concentrates may be packaged in single or multiple serving a squeeze containers that may be fanciful in shape, such a bottle-shaped.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A flavoring concentrate composition comprising:
a flavor component;
a solvent system;
a sweetener;
an acid; and
water, wherein the water is present in the composition in an amount to achieve a water activity of about 0.6 to about 0.75.

2. The composition of claim 1, wherein the solvent system comprises propylene glycol in an amount from about 35 wt. % to 45 wt. % of the composition.

3. The composition of claim 1, wherein the flavor component comprises at least one flavor selected from a group consisting of berry, orange, lemon, strawberry, kiwi, grape, peach, coconut, and punch.

4. The composition of claim 1, wherein the flavor component is present in the composition in an amount from about 2 wt. % to about 8 wt. %.

5. The composition of claim 1, wherein the acid comprises at least one acid selected from a group consisting of citric acid, malic acid, tartaric acid, fumaric acid, and phosphoric acid.

6. The composition of claim 1, wherein the acid comprises citric acid and wherein the citric acid is present in the composition in an amount from about 8 wt. % to about 20 wt. %.

7. The composition of claim 1, wherein the acid comprises potassium citrate and wherein the potassium citrate is present in the composition in an amount from about 0.5 wt. % to about 2 wt. %.

8. The composition of claim 1, wherein the acid comprises citric acid in an amount from about 8 wt. % to about 20 wt. % of the composition and potassium citrate in an amount from about 0.5 wt. % to about 2 wt. % of the composition.

9. The composition of claim, 1 further comprising an additive selected from a group consisting of vitamins, herbal supplements, colorings, minerals, bioactives, fiber, and hydrocolloids.

10. The composition of claim 1, further comprising at least one of inulin and maltodextrine.

11. The composition of claim 1, wherein the composition is a liquid.

12. The composition of claim 1, wherein the composition is a gel.

13. The composition of claim 1, wherein the sweetener is stevia leaf extract.

14. The composition of claim 1, wherein the stevia is present in the composition in an amount from about 2 wt. % to about 4 wt. %.

15. A process for preparing a flavoring concentrate composition comprising the steps of:
a. heating water to about 180 degrees F.;
b. adding an acid, sweetener, and a solvent system to the water to form an initial blend;
c. mixing the initial blend;
d. cooling the initial blend to about 90 degrees F.;
e. adding a flavor component to the blend to form a flavored blend.
f. mixing the flavored blend to form the flavoring concentrate composition; and
g. packaging the flavoring concentrate composition, wherein the water is present in the composition in an amount to achieve a water activity of about 0.6 to about 0.75.

16. The process of claim 15, wherein the acid comprises potassium citrate and citric acid.

17. The process of claim 15, wherein the solvent system comprises propylene glycol in an amount from about 35 wt. % to 45 wt. % of the composition.

18. The process of claim 15, wherein the flavor component is present in the composition in an amount from about 2 wt. % to about 8 wt. %.

19. The process of claim 15, wherein the acid comprises citric acid in an amount from about 8 wt. % to about 20 wt. % of the composition and potassium citrate in an amount from about 0.5 wt. % to about 2 wt. % of the composition.

20. A flavoring concentrate composition comprising:
a flavor component;
a solvent system;
a sweetener;
an acid; and
water, wherein:
the water is present in the composition in an amount to achieve a water activity of about 0.6 to about 0.75;
the solvent system comprises propylene glycol in an amount from about 35 wt. % to 45 wt. % of the composition;
the flavor component is present in the composition in an amount from about 2 wt. % to about 8 wt. %; and
the acid comprises citric acid in an amount from about 8 wt. % to about 20 wt. % of the composition and potassium citrate in an amount from about 0.5 wt. % to about 2 wt. % of the composition.
